(19) United States
(12) Patent Application Publication
(10) Pub. No.: US 2025/0204484 A1
(43) Pub. Date: Jun. 26, 2025

(54) UNIVERSAL PET BED COVER

(71) Applicant: Annie Lee Clark, Sandpoint, ID (US)

(72) Inventor: Annie Lee Clark, Sandpoint, ID (US)

(21) Appl. No.: 18/991,624

(22) Filed: Dec. 22, 2024

Related U.S. Application Data
(60) Provisional application No. 63/614,456, filed on Dec. 22, 2023.

(51) Int. Cl. A01K 1/035

(52) U.S. Cl. CPC A01K 1/0353

(57) ABSTRACT

In an embodiment of the technology disclosed herein, a removable pet bed cover for encasing and protecting pet beds of various shapes and sizes includes two fabric sheets having substantially equal dimensions that are joined together along a portion of their perimeters to form an interior cavity configured to receive a pet bed. The removable pet bed cover further includes a closure mechanism disposed along a remaining portion of the perimeters. The closure mechanism is configured to allow selective opening and closing of the interior cavity. The removable pet bed cover is configured to fully enclose the pet bed within the interior cavity when the closure mechanism is closed and is removable from the pet bed for laundering when the closure mechanism is open.

### CROSS-REFERENCE TO RELATED APPLICATIONS

This application claims priority to U.S. Provisional Application No. 63/614,456 titled “DOG BED COVER”, filed Dec. 22, 2023, which is incorporated herein by reference in its entirety for all purposes.

### TECHNICAL FIELD

The present technology relates to pet accessories. More specifically, the technology disclosed herein includes a universal pet bed cover designed to fit over a variety of pet bed shapes.

### BACKGROUND

Traditional pet beds (e.g., dog beds and cat beds) often lack designs that prioritize ease of maintenance, presenting significant challenges for pet owners. A common issue is the absence of a removable cover, which complicates cleaning and maintaining hygiene. This deficiency makes it difficult to address spills, accidents, or routine cleaning needs, leaving pet owners with limited options to ensure a sanitary sleeping environment for their pets.

Although some pet beds include removable covers, these covers are frequently designed with tight fittings, making removal and reattachment cumbersome. This tight fit not only hinders cleaning but also contributes to increased wear and tear on the pet bed's filling during the removal and reinstallation processes, thereby reducing the product's lifespan.

Furthermore, existing removable covers are typically designed to fit only the specific pet bed they accompany, making them unsuitable for use with other pet beds. This lack of versatility further limits pet owners' ability to maintain cleanliness and extend the functionality of their pet's sleeping environment. The inconvenience associated with such designs often discourages pet owners from cleaning the covers regularly, which can result in unsanitary living conditions for both the pet and its owner.

Moreover, pet bed covers exist that utilize one or more elastic bands to secure the cover over the top of the pet bed. While this approach offers one solution, it has several drawbacks that limit its effectiveness. For example, this approach is largely unworkable for pet beds that lack a rigid structure, where the tension from the elastic can cause non-rigid pet beds to deform, crumple, or shift, compromising the bed's comfort for the pet and its aesthetic appeal.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to pet accessories. More specifically, the technology disclosed herein includes a universal pet bed cover designed to fit over a variety of pet bed shapes. In a first embodiment, a removable pet bed cover for encasing and protecting rectangular pet beds of varying shapes includes a first fabric sheet making up a top side of the removable pet bed cover and a second fabric sheet making up a bottom side of the removable pet bed cover. The first fabric sheet and the second fabric sheet each have a rectangular shape with four sides and substantially equal dimensions. The first fabric sheet and the second fabric sheet are joined together along at least two of the four sides of the first fabric sheet and the second fabric sheet to form an interior cavity configured to receive a rectangular pet bed. The removable pet bed cover further includes a closure mechanism disposed along at least a portion of a fourth side of the four sides of the first fabric sheet and the second fabric sheet. The closure mechanism is configured to allow selective opening and closing of the interior cavity. The removable pet bed cover is configured to fully enclose the rectangular pet bed within the interior cavity when the closure mechanism is closed and is removable from the rectangular pet bed for laundering when the closure mechanism is open.

In some implementations of the first embodiment, the removable pet bed cover of claim 1 further includes at least one adjustable feature. The at least one adjustable feature may be selected from a group consisting of a drawstring, an elastic band, a hook-and-loop fastener, a snap fastener, a hook and eye fastener, and a button fastener. In some implementations of the first embodiment, the first fabric sheet and the second fabric sheet are joined together via one or more of the following: stitching, heat-sealing, ultrasonic welding, or gluing. In some implementations of the first embodiment, the closure mechanism comprises a zipper, a hook-and-loop fastener, buttons, snaps, or a drawstring. In some implementations of the first embodiment, the removable pet bed cover is machine-washable and tumble-dryable. In some implementations of the first embodiment, the second fabric sheet comprises a non-slip feature, the non-slip feature comprising non-slip pads, a textured coating, or an applied material. In some implementations of the first embodiment, the first fabric sheet and the second fabric sheet are formed from a single piece of rectangular fabric folded along one edge to create the top side and the bottom side of the removable pet bed cover. In some implementations of the first embodiment, the closure mechanism is disposed along at least a portion of the fourth side and at least a portion of a third side of the four edges of the first fabric sheet and the second fabric sheet.

In a second embodiment, a removable pet bed cover for encasing and protecting pet beds of varying shapes includes a first fabric sheet making up a top side of the removable pet bed cover and a second fabric sheet making up a bottom side of the removable pet bed cover. The first fabric sheet and the second fabric sheet each have a round shape and substantially equal dimensions. The first fabric sheet and the second fabric sheet are joined together along a portion of the perimeter of the first fabric sheet and the second fabric sheet to form an interior cavity configured to receive a pet bed. The removable pet bed cover further includes a closure mechanism disposed along a remaining portion of the perimeter of the first fabric sheet and the second fabric sheet. The closure mechanism is configured to allow selective opening and closing of the interior cavity. The removable pet bed cover is configured to fully enclose the pet bed within the interior cavity when the closure mechanism is closed and is removable from the pet bed for laundering when the closure mechanism is open.

In some implementations of the second embodiment, the first fabric sheet and the second fabric sheet are joined together via one or more of the following: stitching, heat-sealing, ultrasonic welding, or gluing. In some implementations of the second embodiment, the closure mechanism comprises a zipper, a hook-and-loop fastener, buttons, snaps, or a drawstring. In some implementations of the second embodiment, the removable pet bed cover is machine-washable and tumble-dryable. In some implementations of the second embodiment, the second fabric sheet comprises a non-slip feature, the non-slip feature comprising non-slip pads, a textured coating, or an applied material. In some implementations of the second embodiment, the remaining portion of the perimeter of the first fabric sheet and the second fabric sheet comprises between one fourth and three fourths of the perimeter.

In a third embodiment, a removable dog bed cover for encasing and protecting dog beds of varying shapes includes a first fabric sheet making up a top side of the removable dog bed cover and a second fabric sheet making up a bottom side of the removable dog bed cover. The first fabric sheet and the second fabric sheet each have substantially equal dimensions. The first fabric sheet and the second fabric sheet are joined together along a portion of a perimeter of the first fabric sheet and a perimeter of the second fabric sheet to form an interior cavity configured to receive a dog bed. The removable dog bed cover further includes a closure mechanism disposed along a remaining portion of the perimeter of the first fabric sheet and the perimeter of the second fabric sheet. The closure mechanism is configured to allow selective opening and closing of the interior cavity. The removable dog bed cover is configured to fully enclose the dog bed within the interior cavity when the closure mechanism is closed and is removable from the dog bed for laundering when the closure mechanism is open.

In some implementations of the third embodiment, the removable dog bed cover further includes at least one adjustable feature, the at least one adjustable feature being selected from a group consisting of a drawstring, an elastic band, a hook-and-loop fastener, a snap fastener, a hook and eye fastener, and a button fastener. In some implementations of the third embodiment, the first fabric sheet and the second fabric sheet are joined together via one or more of the following: stitching, heat-sealing, ultrasonic welding, or gluing. In some implementations of the third embodiment, the closure mechanism comprises a zipper, a hook-and-loop fastener, buttons, snaps, or a drawstring. In some implementations of the third embodiment, the first fabric sheet and the second fabric sheet are made from a water-resistant material configured to prevent penetration of water into the interior cavity. In some implementations of the third embodiment, the second fabric sheet comprises a non-slip feature, the non-slip feature comprising non-slip pads, a textured coating, or an applied material.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a rectangular pet bed cover and various types of rectangular pet beds onto which the cover may be installed;

FIG. 2 illustrates an example of a round pet bed cover and various types of round pet beds onto which the cover may be installed;

FIGS. 3A-3B illustrate an example of the construction of a rectangular pet bed cover in accordance with some embodiments of the present technology; and

FIGS. 4A-4B illustrate an example of the construction of a round pet bed cover in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The technology disclosed herein generally relates to pet accessories. More specifically, a universal pet bed cover is disclosed that addresses the limitations associated with traditional pet beds that either lack a removable cover or have a tightly fitted cover, making removal and washing a burdensome task. The pet bed cover disclosed herein enhances the convenience and hygiene aspects of pet beds by introducing a novel design for a removable cover that is easy to take on and off, facilitating regular cleaning and ease of use. By addressing the drawbacks of traditional pet bed covers, this technology disclosed herein sets a new standard in pet comfort and hygiene, offering a solution that meets the practical needs of both pets and their owners.

Traditional pet beds commonly feature designs that do not prioritize the ease of maintenance. One prevalent issue is the absence of a removable cover, resulting in difficulties in cleaning and maintaining hygiene standards. Pet (e.g., dog and cat) owners often encounter challenges in addressing spills, accidents, or simply maintaining a clean sleeping environment for their canine or feline companions due to dirt, pet hair, and other common debris that may build up on a pet bed.

While some existing pet beds offer removable covers, these covers are frequently characterized by tight, custom fittings, making the removal and reattachment processes difficult. The tight fit not only poses challenges during cleaning, but its removal and reattachment also causes more wear and tear on the pet bed filling, diminishing its longevity. The inconvenience associated with removing and re-installing pet bed covers can discourage pet owners from maintaining a consistent cleaning schedule, potentially leading to unhygienic living conditions for both the pet and its caretaker.

Additionally, traditional pet bed covers are customized to fit a specific pet bed. For example, a company may make a fitted cover for their own pet bed, but pet bed covers that may fit a variety of products and brands are generally unavailable. This is despite the fact that traditional pet beds are generally available in a few general shapes, usually rectangular, oval, or circular. The standardized shapes make it possible to create pet bed covers that are suitable for more than a single pet bed product or brand.

The other type of pet bed cover currently available is a fitted sheet cover that utilizes elastic, much like a fitted sheet for a regular bed. While this approach offers one solution, it has several drawbacks that limit its effectiveness. For example, this approach is largely unworkable for pet beds that lack a rigid structure, where the tension from the elastic can cause soft or non-rigid pet beds to deform, crumple, or shift, compromising the bed's comfort for the pet and its aesthetic appeal. Additionally, elastic-secured covers do not provide complete coverage, leaving the sides and bottom of the pet bed exposed to dirt, spills, and other contaminants. This partial protection reduces the overall utility of the cover and makes it less effective for maintaining hygiene. In contrast, a fully enclosed pet bed cover is designed to protect all surfaces of the pet bed while also ensuring that the bed retains its shape.

Recognizing the popularity of dog beds featuring bolsters for added comfort and support, the cover extends its applicability to this design. The cover is crafted to fit over both the mattress and bolstered sides of the bed or couch. The integration of bolsters introduces an additional level of complexity, as traditional covers for such beds often pose challenges and/or extra steps during removal and washing.

The technology disclosed herein seeks to overcome these challenges by introducing a novel pet bed cover design that addresses the limitations of both non-removable covers, elastic covers, and covers with tight or custom fittings. The proposed cover design allows for easy removal and installation, streamlining the cleaning process and promoting regular maintenance of a clean and comfortable sleeping environment for dogs and cats.

The removable cover disclosed herein provides a modular and customizable approach to pet bed covers, accommodating a variety of shapes and sizes to cater to the diverse needs of different pet breeds. This innovation not only enhances convenience for pet owners but also ensures a more comfortable and adaptable resting place for their beloved companion.

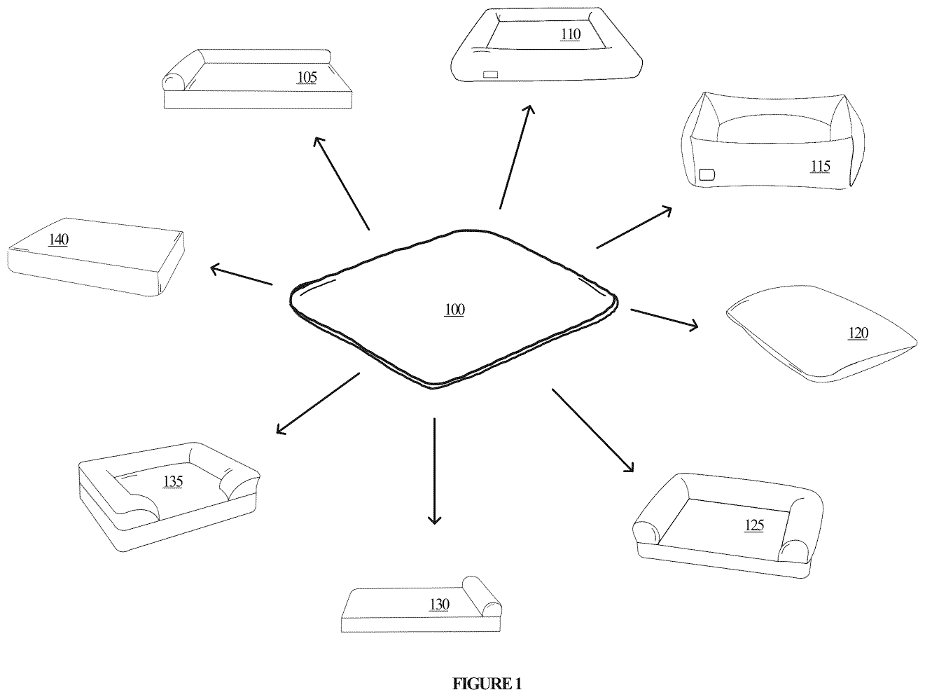

FIG. 1 illustrates a universal pet bed cover (cover 100) for encasing and protecting pet beds, and a variety of pet beds onto which the cover can be installed. Cover 100 is representative of a removable pet bed cover having a rectangular shape in accordance with some embodiments of the present technology. FIG. 1 includes cover 100, bed 105, bed 110, bed 115, bed 120, bed 125, bed 130, bed 135, and bed 140. The pet beds included in the example of FIG. 1 are merely for purposes of example and are not intended to limit the shapes, styles, or sizes of pet beds on which cover 100 may be utilized.

As used herein, the term rectangular refers to a substantially rectangular shape and is not limited to precise right angles or exactly equal side lengths. The term rectangular encompasses variations such as rounded corners, slightly irregular edges, or minor deviations in length or angle that do not materially depart from the general rectangular form.

Bed 105, bed 110, bed 115, bed 120, bed 125, bed 130, bed 135, and bed 140 are pet beds of various sizes and styles, showing the applicability of cover 100 across a range of pet beds. The examples of bed 105, bed 110, bed 115, bed 120, bed 125, bed 130, bed 135, and bed 140 include beds with bolstered edges, flat cushions, and varying thicknesses.

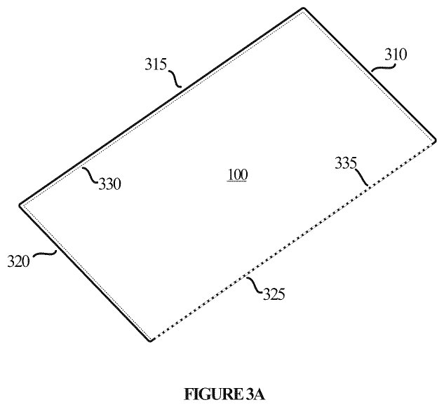

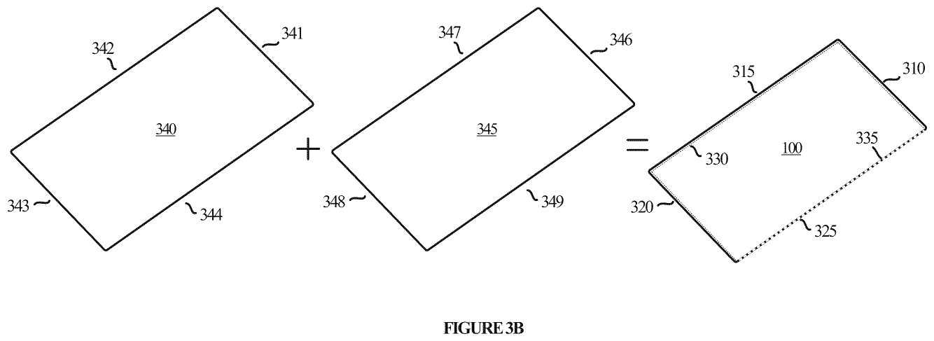

As described in greater detail in FIGS. 3A-3B, cover 100, in some embodiments, includes a first fabric sheet forming the top surface and a second fabric sheet forming the bottom surface. These fabric sheets are joined together, creating an interior cavity sized to receive and fully enclose any of bed 105, bed 110, bed 115, bed 120, bed 125, bed 130, bed 135, and bed 140. At least one side includes a closure mechanism for selective opening and closing of the cover, such as a zipper, which extends along a substantial portion of the edge (e.g., more than 50%). This closure mechanism facilitates easy opening and closing of the interior cavity, allowing for the convenient insertion and removal of the pet bed while fully enclosing the pet bed when the cover is in use.

Additionally, cover 100 may include optional features to enhance functionality. For example, the second fabric sheet may incorporate non-slip elements, such as textured coatings or non-slip pads, to prevent unwanted movement of the pet bed on smooth surfaces. Furthermore, the fabric sheets can be constructed from machine-washable materials to simplify cleaning and maintenance. The inclusion of these features ensures that cover 100 provides comprehensive protection, ease of use, and adaptability for both pets and their owners. The fabric sheets making up the two sides of cover 100, in some examples, are formed from a single piece of rectangular fabric folded along one edge to create the top side and the bottom side of the removable pet bed cover. In such an example, the sheets may be permanently affixed together via stitching or other means on only two of the four sides of the rectangle, where the fourth side is brought together via a closure mechanism such as a zipper and the third side is attached via the continuous piece of fabric making up the first and second sheet.

Cover 100 may further include at least one adjustable feature provided for adjusting the fit of cover 100 onto various pet beds. The adjustable feature may include one or more drawstrings, elastic bands, hook-and-loop fasteners, snap fasteners, hook and eye fasteners, and button fasteners. The adjustable feature is distinct from the closure mechanism used on cover 100. The adjustable feature creates a more versatile pet bed cover that can fit over a wider range of pet bed shapes and sizes by allowing the cover to be tightened or otherwise adjusted as appropriate for a given pet bed. The adjustable feature, in some examples, is mounted on one side of the cover, such as the bottom, so that it is out of view when the cover is installed on a pet bed and lying on a flat surface such as the floor.

The materials used for cover 100 may include natural fibers such as cotton or linen, synthetic materials such as polyester or nylon, or blends of these fibers. In some embodiments, waterproof or water-resistant materials may be utilized to protect the enclosed pet bed from spills and accidents. For added durability, reinforced stitching or high-strength textiles may be employed, particularly for covers intended for large or active pets. The selected materials may also incorporate antimicrobial or odor-resistant treatments to further help with hygiene and/or odors. In exemplary embodiments, cover 100 is composed of fabrics that are machine-washable and tumble-dryable.

The first and second fabric sheets may be joined together using a variety of bonding techniques, including traditional stitching, heat-sealing, adhesive bonding, and/or ultrasonic welding. Each method may be chosen based on the type of material and the desired level of durability and aesthetics. For example, stitching may provide a classic and visually appealing finish, while heat-sealing may be preferred for waterproof materials.

The closure mechanism can also vary, with options including one or more zippers, hook-and-loop fasteners, hook and eye fasteners, buttons, snaps, drawstrings, elastic bands, or a combination thereof. In some examples, zippers may be utilized for a secure and seamless enclosure, while hook-and-loop fasteners or drawstrings may provide additional adjustability and ease of use in other examples.

As mentioned earlier, pet beds compatible with cover 100 include various styles and designs catering to different pet and owner needs. These include flat cushion beds (e.g., bed 120 and/or bed 140) and orthopedic beds, often thicker and made with memory foam or other supportive materials to aid older or arthritic pets. Other types include bolstered beds and/or couch-style beds featuring raised edges for added comfort and security (e.g., bed 105, bed 110, bed 115, bed 125, bed 130, and/or bed 135), as well as multi-layer beds with removable inner cushions that add versatility. Additionally, beds with waterproof liners for outdoor or accident-prone use are also compatible.

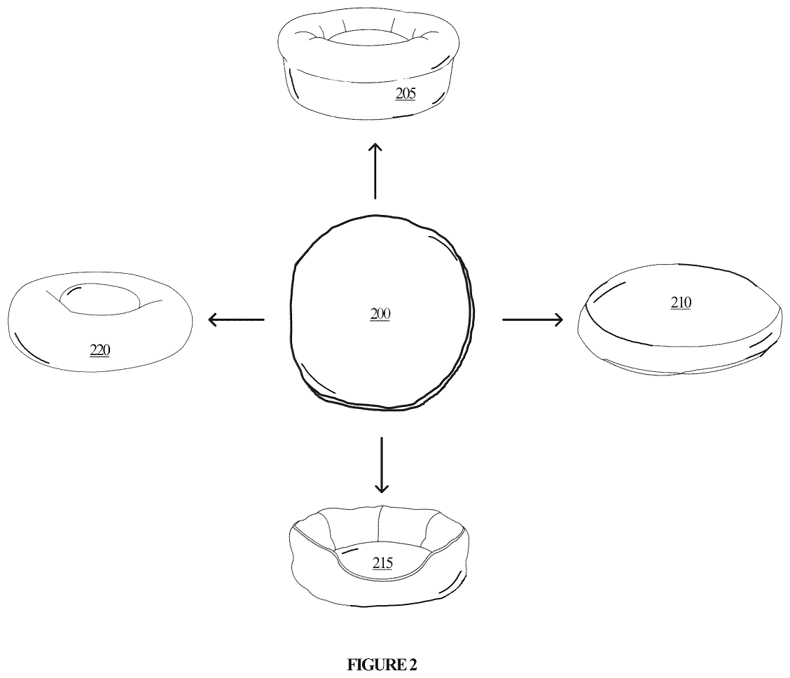

FIG. 2 illustrates a universal pet bed cover (cover 200) for encasing and protecting pet beds, and a variety of pet beds onto which the cover can be installed. Cover 200 is representative of a removable pet bed cover having a round (circular, oval, or similar) shape in accordance with some embodiments of the present technology. FIG. 2 includes cover 200, bed 205, bed 210, bed 215, and bed 220. The pet beds included in the example of FIG. 2 are merely for purposes of example and are not intended to limit the shapes, styles, or sizes of pet beds on which cover 200 may be utilized.

As used herein, the term “round” refers to a substantially round shape and is not limited to perfectly circular forms. It encompasses variations such as oval shapes, elliptical forms, and other curvilinear configurations and other substantially round shapes with minor deviations. Deviations may include slight irregularities in curvature, variations in diameter, or asymmetrical contours that do not materially depart from the general round appearance. This broad interpretation ensures compatibility with a wide variety of round pet beds, including those with unique or unconventional designs, while maintaining the intended functionality and adaptability of the cover.

Bed 205, bed 210, bed 215, and bed 220 are pet beds of various sizes and styles, showing the applicability of cover 200 across a range of pet beds. The examples of bed 205, bed 210, bed 215, and bed 220 include beds with bolstered edges, flat cushions, and varying thicknesses.

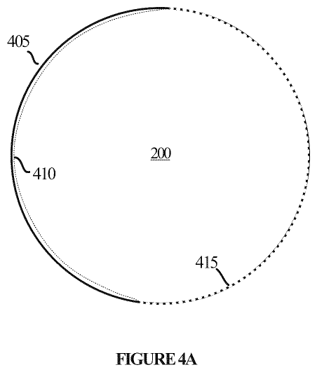

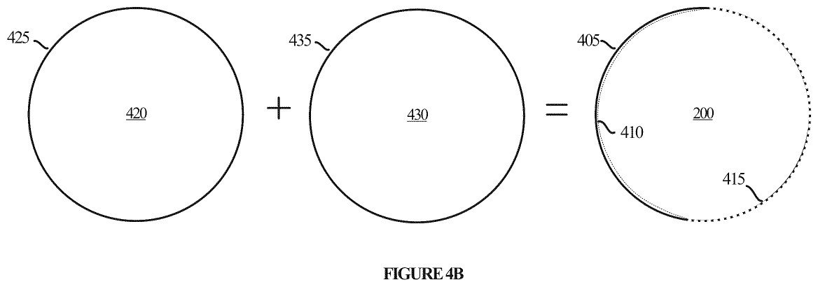

As described in greater detail in FIGS. 4A-4B, cover 200, in some embodiments, includes a first fabric sheet forming the top surface and a second fabric sheet forming the bottom surface. These fabric sheets are joined together, creating an interior cavity sized to receive and fully enclose any of bed 205, bed 210, bed 215, and bed 220. The first and second fabric sheet are joined together along a portion of the edge where they meet. The portion of the edge along which the sheets are joined together may vary in different implementations. For example, in some embodiments the first and second sheet are joined together along approximately half (e.g., 50%) of their total circumference, wherein a closure mechanism encompasses the other half of the circumference. In other examples, the first and second sheet may be joined together along less than half (e.g., 25%) of their circumference, with the closure mechanism encompassing the rest (e.g., 75%) of the circumference. Still in other examples, the first and second sheet may be joined together along more than half (e.g., 75%) of their circumference with the closure mechanism along the rest (e.g., 25%) of the circumference.

Additionally, cover 200 may include optional features to enhance functionality. For example, the second fabric sheet may incorporate non-slip elements, such as textured coatings or non-slip pads, to prevent unwanted movement of the pet bed on smooth surfaces. Furthermore, the fabric sheets can be constructed from machine-washable materials to simplify cleaning and maintenance. The inclusion of these features ensures that cover 200 provides comprehensive protection, ease of use, and adaptability for both pets and their owners.

The materials used for cover 200 may include natural fibers such as cotton or linen, synthetic materials such as polyester or nylon, or blends of these fibers. In some embodiments, waterproof or water-resistant materials may be utilized to protect the enclosed pet bed from spills and accidents. For added durability, reinforced stitching or high-strength textiles may be employed, particularly for covers intended for large or active pets. The selected materials may also incorporate antimicrobial or odor-resistant treatments to further help with hygiene and/or odors. In exemplary embodiments, cover 200 is composed of fabrics that are machine-washable and tumble-dryable.

The first and second fabric sheets of cover 200 may be joined together using a variety of bonding techniques, including traditional stitching, heat-sealing, adhesive bonding, and/or ultrasonic welding. Each method may be chosen based on the type of material and the desired level of durability and aesthetics. For example, stitching may provide a classic and visually appealing finish, while heat-sealing may be preferred for waterproof materials.

The closure mechanism of cover 200 can also vary, with options including one or more zippers, hook-and-loop fasteners, hook and eye fasteners, buttons, snaps, drawstrings, elastic bands, or a combination thereof. In some examples, zippers may be utilized for a secure and seamless enclosure, while hook-and-loop fasteners or drawstrings may provide additional adjustability and ease of use in other examples.

As mentioned earlier, pet beds compatible with cover 200 include various styles and designs catering to different pet and owner needs. These include flat cushion beds (e.g., bed 210) and orthopedic beds, often thicker and made with memory foam or other supportive materials to aid older or arthritic pets. Other types include bolstered beds and/or couch-style beds featuring raised edges for added comfort and security (e.g., bed 205, bed 215, and/or bed 220), as well as multi-layer beds with removable inner cushions that add versatility. Additionally, beds with waterproof liners for outdoor or accident-prone use are also compatible.

FIGS. 3A-3B illustrate an example of the construction of a rectangular pet bed cover (cover 100) in accordance with some embodiments of the present technology. Cover 100 includes sheet 340, sheet 345, side 310, side 315, side 320, side 325, seam 330, and zipper 335. Sheet 340 makes up the top side of cover 100 and has a perimeter that includes side 341, side 342, side 343, and side 344. Sheet 345 makes up the bottom side of cover 100 and has a perimeter that includes side 346, side 347, side 348, and side 349. Sheet 340 and sheet 345 have substantially equal dimensions and are joined together along their edges to form cover 100. Side 341 and side 346 are joined together at seam 330 to form side 310. Side 342 and side 347 are joined together at seam 330 to form side 315. Side 343 and side 348 are joined together at seam 330 to form side 320. Side 344 and side 349 are joined together (but separable) by zipper 335 to form side 325.

Cover 100 includes side 310, side 315, side 320, side 325, seam 330, and zipper 335. Seam 330 extends along at least a substantial portion of side 310, side 315, and side 320, joining two fabric sheets of cover 100 together. Zipper 335 is disposed along at least a substantial portion of side 325 for selective opening and closing of cover 100. Thus, in some examples, zipper 335 may not extend across the entirety of side 325. Instead, sheet 340 and sheet 345 may be joined together along side 325 with a seam (e.g., stitching) that extends along a small portion of side 325, while zipper 335 extends along the remaining substantial portion of side 325.

In other examples, seam 330 and zipper 335 may extend along different percentages or sides making up the perimeter of cover 100. For example, seam 330 may join together a substantial portion of only two sides of sheet 340 and sheet 345 (e.g., side 341 with side 346 and side 342 with side 347), while zipper 335 or a different closure mechanism extends along a substantial portion of the other two sides of sheet 340 and sheet 345 (e.g., joining side 343 with side 348 and side 344 with side 349).

Seam 330 may be constructed using a variety of bonding techniques, including stitching, heat-sealing, ultrasonic welding, or adhesive bonding, depending on the materials used and the desired strength of the seams. For example, stitching may provide flexibility and a traditional aesthetic, while heat-sealing could be used for waterproof or water-resistant covers.

Zipper 335 is an example of a closure mechanism that may be used in accordance with the example of cover 100. Zipper 335 is disposed along a substantial portion of side 325, allowing for selective opening and closing of the interior cavity formed by the joined fabric sheets. Zipper 335 is a zipper in the current example for secure and durable fastening, although alternatives such as hook-and-loop fasteners, buttons, snaps, or drawstrings could also be used based on user preference or specific design requirements. In some embodiments, the closure mechanism may include a protective flap or overlap to shield the mechanism from dirt and debris.

Other optional features of cover 100 to enhance usability and functionality may include non-slip pads throughout or at strategic points to prevent movement of the cover on smooth surfaces. Additionally, reinforced stitching or double seams along the entirety of cover 100 or only in high-stress areas, such as corners or edges near the closure mechanism, may be used to provide durability under repeated use.

Cover 100 may further include at least one adjustable feature provided for adjusting the fit of cover 100 onto various pet beds. The adjustable feature may include one or more drawstrings, elastic bands, hook-and-loop fasteners, snap fasteners, hook and eye fasteners, and button fasteners. The adjustable feature is distinct from the closure mechanism used on cover 100. The adjustable feature creates a more versatile pet bed cover that can fit over a wider range of pet bed shapes and sizes by allowing the cover to be tightened or otherwise adjusted as appropriate for a given pet bed. The adjustable feature, in some examples, is mounted on one side of the cover, such as the bottom, so that it is out of view when the cover is installed on a pet bed and lying on a flat surface such as the floor.

The fabric(s) used for sheet 340 and sheet 345 may include natural fibers such as cotton and linen, synthetic materials such as polyester and nylon, or blends of natural and synthetic fibers. The fabrics may also incorporate specialized treatments, such as antimicrobial coatings, waterproof layers, or stain-resistant finishes.

FIGS. 4A-4B illustrate an example of the construction of a round pet bed cover (cover 200) in accordance with some embodiments of the present technology. Cover 200 includes sheet 420, sheet 430, perimeter 405, seam 410, and zipper 415. Sheet 420 makes up the top side of cover 200 and includes perimeter 425. Sheet 430 makes up the bottom side of cover 200 and includes perimeter 435. Sheet 420 and sheet 430 have substantially equal dimensions and are joined together along their perimeters to form cover 200. A portion of perimeter 425 and a corresponding portion of perimeter 435 are joined together at seam 410 to form a portion of perimeter 405. Another portion of perimeter 425 and another portion of perimeter 435 are joined together (but separable) by zipper 415 to fill in the rest of perimeter 405.

Seam 410, in some examples, extends along approximately half of perimeter 405, with zipper 415 extending along the remaining half of perimeter 405. However, in other examples, seam 410 and zipper 415 may make up difference portions of perimeter 405. For example, seam 410 may extend along approximately one fourth of perimeter 405 with zipper 415 extending along the remaining three fourths of perimeter 405. Alternatively, seam 410 may extend along approximately three fourths of perimeter 405 with zipper 415 extending along the remaining one fourth of perimeter 405. Other combinations and variations exist and these examples provided herein are solely for purposes of example.

Seam 410 may be constructed using a variety of bonding techniques, including stitching, heat-sealing, ultrasonic welding, or adhesive bonding, depending on the materials used and the desired strength of the seams. For example, stitching may provide flexibility and a traditional aesthetic, while heat-sealing could be used for waterproof or water-resistant covers.

Zipper 415 is an example of a closure mechanism for the selective opening and closing of cover 200. Zipper 415 is disposed along a portion of perimeter 405, allowing for selective opening and closing of the interior cavity formed by the joined fabric sheets. Zipper 415 is a zipper in the current example for secure and durable fastening, although alternatives such as hook-and-loop fasteners, buttons, snaps, or drawstrings could also be used based on user preference or specific design requirements. In some embodiments, the closure mechanism may include a protective flap or overlap to shield the mechanism from dirt and debris.

Other optional features of cover 200 to enhance usability and functionality may include non-slip pads throughout or at strategic points to prevent movement of the cover on smooth surfaces. Additionally, reinforced stitching or double seams along the entirety of cover 200 or only in high-stress areas, such as near the closure mechanism, may be used to provide durability under repeated use.

Cover 200 may further include at least one adjustable feature provided for adjusting the fit of cover 200 onto various pet beds. The adjustable feature may include one or more drawstrings, elastic bands, hook-and-loop fasteners, snap fasteners, hook and eye fasteners, and button fasteners. The adjustable feature is distinct from the closure mechanism used on cover 200. The adjustable feature creates a more versatile pet bed cover that can fit over a wider range of pet bed shapes and sizes by allowing the cover to be tightened or otherwise adjusted as appropriate for a given pet bed. The adjustable feature, in some examples, is mounted on one side of the cover, such as the bottom, so that it is out of view when the cover is installed on a pet bed and lying on a flat surface such as the floor.

The fabric(s) used for sheet 420 and sheet 420 may include natural fibers such as cotton and linen, synthetic materials such as polyester and nylon, or blends of natural and synthetic fibers. The fabrics may also incorporate specialized treatments, such as antimicrobial coatings, waterproof layers, or stain-resistant finishes.

The above description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described herein can be combined in various ways to form multiple variations of the invention. As a result, the invention is not limited to the specific examples described herein, but only by the claims and their equivalents.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A removable pet bed cover for encasing and protecting rectangular pet beds of varying shapes, the removable pet bed cover comprising:
a first fabric sheet making up a top side of the removable pet bed cover;
a second fabric sheet making up a bottom side of the removable pet bed cover, wherein:
the first fabric sheet and the second fabric sheet each have a rectangular shape with four sides and substantially equal dimensions; and
the first fabric sheet and the second fabric sheet are joined together along at least two of the four sides of the first fabric sheet and the second fabric sheet to form an interior cavity configured to receive a rectangular pet bed; and
a closure mechanism disposed along at least a portion of a fourth side of the four sides of the first fabric sheet and the second fabric sheet, wherein the closure mechanism is configured to allow selective opening and closing of the interior cavity;
wherein the removable pet bed cover is configured to fully enclose the rectangular pet bed within the interior cavity when the closure mechanism is closed and is removable from the rectangular pet bed for laundering when the closure mechanism is open.

2. The removable pet bed cover of claim 1 further comprising at least one adjustable feature, the at least one adjustable feature being selected from a group consisting of a drawstring, an elastic band, a hook-and-loop fastener, a snap fastener, a hook and eye fastener, and a button fastener.

3. The removable pet bed cover of claim 1, wherein the first fabric sheet and the second fabric sheet are joined together via one or more of the following: stitching, heat-sealing, ultrasonic welding, or gluing.

4. The removable pet bed cover of claim 1, wherein the closure mechanism comprises a zipper, a hook-and-loop fastener, buttons, snaps, or a drawstring.

5. The removable pet bed cover of claim 1, wherein the removable pet bed cover is machine-washable and tumble-dryable.

6. The removable pet bed cover of claim 1, wherein the second fabric sheet comprises a non-slip feature, the non-slip feature comprising non-slip pads, a textured coating, or an applied material.

7. The removable pet bed cover of claim 1, wherein the first fabric sheet and the second fabric sheet are formed from a single piece of rectangular fabric folded along one edge to create the top side and the bottom side of the removable pet bed cover.

8. The removable pet bed cover of claim 1, wherein the closure mechanism is disposed along at least a portion of the fourth side and at least a portion of a third side of the four sides of the first fabric sheet and the second fabric sheet.

9. A removable pet bed cover for encasing and protecting pet beds of varying shapes, the removable pet bed cover comprising:
a first fabric sheet making up a top side of the removable pet bed cover;
a second fabric sheet making up a bottom side of the removable pet bed cover, wherein:
the first fabric sheet and the second fabric sheet each have a round shape and substantially equal dimensions; and
the first fabric sheet and the second fabric sheet are joined together along a perimeter of the first fabric sheet and the second fabric sheet to form an interior cavity configured to receive a pet bed; and
a closure mechanism disposed along a remaining portion of the perimeter of the first fabric sheet and the second fabric sheet, wherein the closure mechanism is configured to allow selective opening and closing of the interior cavity;
wherein the removable pet bed cover is configured to fully enclose the pet bed within the interior cavity when the closure mechanism is closed and is removable from the pet bed for laundering when the closure mechanism is open.

10. The removable pet bed cover of claim 9, wherein the first fabric sheet and the second fabric sheet are joined together via one or more of the following: stitching, heat-sealing, ultrasonic welding, or gluing.

11. The removable pet bed cover of claim 9, wherein the closure mechanism comprises a zipper, a hook-and-loop fastener, buttons, snaps, or a drawstring.

12. The removable pet bed cover of claim 9, wherein the removable pet bed cover is machine-washable and tumble-dryable.

13. The removable pet bed cover of claim 9, wherein the second fabric sheet comprises a non-slip feature, the non-slip feature comprising non-slip pads, a textured coating, or an applied material.

14. The removable pet bed cover of claim 9, wherein the remaining portion of the perimeter of the first fabric sheet and the second fabric sheet comprises between one fourth and three fourths of the perimeter.

15. A removable dog bed cover for encasing and protecting dog beds of varying shapes, the removable dog bed cover comprising:
a first fabric sheet making up a top side of the removable dog bed cover;
a second fabric sheet making up a bottom side of the removable dog bed cover, wherein:
the first fabric sheet and the second fabric sheet have substantially equal dimensions; and
the first fabric sheet and the second fabric sheet are joined together along a portion of a perimeter of the first fabric sheet and a perimeter of the second fabric sheet to form an interior cavity configured to receive a dog bed; and
a closure mechanism disposed along a remaining portion of the perimeter of the first fabric sheet and the perimeter of the second fabric sheet, wherein the closure mechanism is configured to allow selective opening and closing of the interior cavity;
wherein the removable dog bed cover is configured to fully enclose the dog bed within the interior cavity when the closure mechanism is closed and is removable from the dog bed for laundering when the closure mechanism is open.

16. The removable dog bed cover of claim 15 further comprising at least one adjustable feature, the at least one adjustable feature being selected from a group consisting of a drawstring, an elastic band, a hook-and-loop fastener, a snap fastener, a hook and eye fastener, and a button fastener.

17. The removable dog bed cover of claim 15, wherein the first fabric sheet and the second fabric sheet are joined together via one or more of the following: stitching, heat-sealing, ultrasonic welding, or gluing.

18. The removable dog bed cover of claim 15, wherein the closure mechanism comprises a zipper, a hook-and-loop fastener, buttons, snaps, or a drawstring.

19. The removable dog bed cover of claim 15, wherein the first fabric sheet and the second fabric sheet are made from a water-resistant material configured to prevent penetration of water into the interior cavity.

20. The removable dog bed cover of claim 15, wherein the second fabric sheet comprises a non-slip feature, the non-slip feature comprising non-slip pads, a textured coating, or an applied material.
